(19) United States
(12) Patent Application Publication
(10) Pub. No.: US 2026/0351540 A1
(43) Pub. Date: Nov. 5, 2026

(54) AN ION DETECTION DEVICE AND A METHOD OF CONTROLLING AN ION DETECTION DEVICE

(71) Applicant: Thermo Fisher Scientific (Bremen) GmbH, Bremen (DE)

(72) Inventor: Hans-Jürgen Schlüter, Bremen (DE)

(73) Assignee: Thermo Fisher Scientific (Bremen) GmbH, Bremen (DE)

(21) Appl. No.: 19/124,499

(22) PCT Filed: Oct. 25, 2023
(86) PCT No.: PCT/EP2023/079748

§ 371 Date: Apr. 25, 2025

(30) Foreign Application Priority Data
Oct. 27, 2022 (GB) 2215883.6

(51) Int. Cl. H01J 49/02; H01J 43/24; H01J 43/30; H01J 49/06

(52) U.S. Cl. CPC H01J 49/025; H01J 43/24; H01J 43/30; H01J 49/061

(57) ABSTRACT

A method of controlling an ion detection device is provided. The method comprises: converting received ions into emitted electrons, multiplying the emitted electrons, detecting the multiplied electrons, producing a detection signal in response, and determining an ion intensity from the detection signal.

### FIELD OF THE INVENTION

The present invention relates to ion detection devices, such as secondary electron multiplier (SEM) detection devices. A SEM detection device may be used to detect ions emerging from a mass analyzer of a mass spectrometer.

### BACKGROUND OF THE INVENTION

FIG. 1 illustrates a simple SEM detection device 10 according to the prior art. A SEM detection device 10 consists of a multiplying section 12 and a detection section 13. An ion beam IB enters the multiplying section, guided by an (optional) deflector 11. When an ion hits a first dynode of the multiplying section or “conversion dynode” 12A, the conversion dynode emits secondary electrons. The conversion dynode is under a suitable electrical potential so that the charged ion is accelerated towards the conversion dynode 12A. The subsequent emission of electrons is called secondary emission.

The electrons emitted from the impact of the ion on the conversion dynode are attracted by an electric field in the direction of the next dynode, where the charges cause emission of secondary electrons. There is a potential difference between the conversion dynode and the next dynode, so that the next dynode emits secondary electrons for each impact of the charge received from the conversion dynode (the second dynode may have a positive potential difference compared to the first, and the third may have a positive potential difference compared to the second, and so on). With multiple subsequent stages it is foreseen that each dynode may have a less negative (more positive) potential, wherein the secondary electrons emitted from a previous dynode are attracted to a next dynode, which may have a more positive potential. Thus, it is possible that a single ion entering the front of the SEM detection device can result in upwards of one million electrons exiting the multiplying section 12 which are directed to the detecting section 13 of the detection device 10, where a pulse detection signal P is produced. In that way and by means of the charge multiplication through the secondary electrons, it is possible to register even an input of a very small number of or even single ions to the SEM detection device.

For inductively coupled plasma mass spectrometry (ICP-MS), for example, a detection device should be able to operate over 9 orders of magnitude of dynamic range, with a target of operating over 11 orders of magnitude of dynamic range. This is so that the detection device is suitable for detecting major and minor components of a sample.

U.S. Pat. No. 7,220,970 B2 describes an example of a SEM detection device and SEM detection device operation modes. A SEM detection device may be used in a counting (or pulse) mode and in a current (or analogue) mode. In ICP-MS, a detection device is generally provided with different sections, the first section being used for analogue mode, while the second section is used for pulse mode (or is switched off), as illustrated in FIG. 1. In order to record the electrons in current (or analogue) mode, an analogue signal is taken from one of the central dynodes or multiplication stages within the multiplying section (as illustrated in FIG. 1). The counting (or pulse) mode records the electrons arriving at the last stage of the SEM detection device (i.e.: the detection section or detector 13). High ion currents can be measured using the analogue mode, while the counting mode evaluates the relatively smaller ion currents. The SEM may be operated selectively in analogue mode and in counting mode in order to provide a wider dynamic measurement range.

Another option to increase the dynamic range of the detection device is employed in the iCAP™ Q instrument of Thermo Fisher Scientific, wherein the electrons after the first n dynodes are taken off the multiplying section of the SEM and diverted into a Faraday cup, where the current is measured.

In counting mode, in which all multiplied electrons are fed to the detector, it has been observed that the detector degrades over time due to the constant exposure to a comparatively high current of electrons. Also, in case of higher counting ranges (about 106 cps or more), the counting mode is affected by saturation effects of the detector. After each peak (burst of multiplied secondary electrons caused by the entrance of an ion into the SEM), the detector needs to be switched off for a certain time, because, after a pulse, the detector may not be fit to support the charges for a next pulse and/or the detector is susceptible to “ringing” leading to double pulses. Also, each pulse may have a different duration (or “pulse width”), depending on the intensity. Any additional pulses falling during this time cannot be detected. In order to mitigate these effects, the counting mode may require a “dead time”, during which the detector is “switched off” for a certain period of time after the detection of each peak. The pulse width can differ for different pulses. Therefore, the dead time has to be at least as long as the longest pulse width to consider. During the time when the detector is “switched off”, the electronics may be switched into a mode in which a count is not registered (although power may still be supplied).

Compared to the counting mode, the analogue mode has a fast reaction time and is therefore sensitive to changes in the ion current. However, drift may occur over time since the analogue signal depends on the age of the dynodes. Therefore, there is an inherent lack of stability and accuracy of the analogue mode detection. Moreover, the average amplification of each dynode may depend on the work function, and therefore residual gas near the detector can cause further drift.

Where both modes are employed to increase the dynamic range of the detection device, the drift of the analogue mode and degradation effects linked to the counting mode need to be accounted for. This is normally done by performing a cross calibration between the counting signal and the analogue signal. Due to the unknown drift/degradation effects, cross calibration needs to be performed on a regular basis. Moreover, the cross calibration is also element dependent and requires calibration agents.

Another approach to increase the dynamic range of the detection device is to down regulate the current at the first dynode(s) by adjusting the dynode voltages to attenuate high-level signals in a mode known as attenuation mode. However, the required voltages in this mode may change with time, which could lead to poor stability. Moreover, the voltage needed is dependent on the mass of the sample ions. If the amplification voltage is increased during this mode, detector aging issues may be worsened (and the device may exhibit a relatively poor plateau). Furthermore, the advantages of counting mode (high precision, linearity, low drift) are not present in attenuation mode. This mode is therefore no better than the analogue mode. In fact, this mode may lack the fast reaction of the analogue mode (e.g. for the protection of the detector) and provides no overlap between the modes, where measurements are taken simultaneously with different attenuation. Instead, it is necessary to make one pre-measurement, measure the intensity, then decide on the attenuation for the mode. If the pre-measurement is not performed, there is a risk of detector damage from a high signal. The plateau curve is also dependent on the attenuation voltage. Therefore, providing an attenuation mode is not a preferred solution to the problem.

The advantages arising from counting mode are weakened by introducing effects that would have been seen in the analogue mode. Additionally, the attenuation has to be pre-set before the analysis. This approach may therefore suffer from the disadvantages of both modes.

### SUMMARY OF THE INVENTION

The present invention aims to provide an ion detection device, such as an SEM detection device, with an increased dynamic range. The present invention also aims to provide an ion detection device with an improved lifetime. The present invention further aims to provide an ion detection device with the ability to measure ion currents in the analogue range but with counting range accuracy and stability. The present invention additionally aims to provide a method of controlling an ion detection device.

Accordingly, a method of controlling an ion detection device is provided. The method comprising:
converting received ions into emitted electrons,
multiplying the emitted electrons,
detecting the multiplied electrons,
producing a detection signal in response, and
determining an ion intensity from the detection signal.

The method comprises controlling the number of multiplied electrons reaching the detector by intermittent gating in dependence of the ion intensity.

According to the invention, an intermittent gating is provided (for example, by gating the secondary electrons within the multiplying section of the SEM detection device and/or gating the ion beam before the ions hit the conversion element). Advantageously, the proposed methods and devices may achieve an improved dynamic range, whilst addressing the shortcomings of the counting mode of previous devices described above. Stability and reproducibility of the SEM detection device may also be improved.

The proposed methods provide a detection device that is capable of providing a large dynamic range, using only the counting mode of the detection device and without requiring an analogue (current) mode. As a result, cross-calibration of analogue and counting modes may not be needed. Therefore, a detector calibration solution for cross calibration may not be required and the time spent performing detector cross calibration may be saved.

By providing intermittent gating, it may be possible to switch the ion stream and/or the stream of secondary electrons on or off (or at least significantly attenuate the stream). By implementing a stochastic algorithm, it may be possible to reduce the overall exposure of the detector to electrons, which reduces degradation of the detector.

Additionally, by implementing intermittent gating according to the proposed methods, switching times may allow for intermittent “dead times”, during which no electrons are received by the detector. In this way, useful readings may be obtained from the detector, while maintaining an overall readiness of the detector. The detector is not overloaded by electrons, as long as the “off” time by the gating is at least as long as the dead time of the detector.

By implementing the invention, the detection device does not necessarily need an analogue section. Thus, technical complexity of the detection device and cost may be reduced. Moreover, calibration of the analogue mode may not be required, which significantly increases the readiness of the instrument and efficiency of operation (and may obviate costs associated with calibration, such as employing calibration agents). There are also benefits for the overall instrument (i.e. the mass spectrometer), as analogue electronics, as well as a dedicated analogue high voltage supply and several feedthroughs, may be omitted compared to the dual-mode SEM detection device of the prior art.

If the counting part of the detection device sees too many counts, it will degrade. As the number of counts on the detector is decreased, detector lifetime is increased. Therefore, by applying intermittent gating to the detection device to improve the range and keeping the number of detection events small, the lifetime of the detector may be improved by the proposed methods. The proposed measurement techniques may also be used for intensities that were previously used for counting detection, but with fewer events needed to make accurate measurements.

In the high counting range (e.g., in the range of more than 1 million counts per second) and the higher ranges previously measured by analogue mode, the proposed methods may determine the ion intensity with fewer detector events. The results may be more accurate and reliable than the methods provided in the prior art.

As mentioned above, the detection device may not need an analogue section. This means that fewer components may be required for the detection device (which may make the detection device less costly). In addition, this may also mean that fewer components are needed in the instrument as a whole, as the following components may no longer be required:
the analogue electronics,
the dedicated analogue high voltage and
several feedthroughs.

In accordance with the proposed methods, the way that ions are counted is changed from a pure counting to a “variable chopping technique”. By providing a variable “chopping” time, and also using this “chopping” time for the data evaluation, the proposed methods provide considerable benefits, as described above.

Determining an ion intensity from the detection signal may comprise determining an ion count value. The number of multiplied electrons reaching the detector of the detection device may be controlled by intermittent gating in dependence on the count value.

The conversion element may also be referred to as the conversion electrode or conversion dynode. The multiplication unit may comprise a plurality of electrodes, which may also be referred to as dynodes.

The multiplication unit may be for multiplying the emitted electrons downstream of the conversion element. The detector may be downstream of the multiplication unit.

The method may further comprise:
emitting electrons upon receiving ions (by the conversion element),
multiplying the emitted electrons (by the multiplication unit),
detecting a pulse of the multiplied electrons and producing a detection signal in response (by the detector), and
determining a count value from the detection signal (by the detector or by a processor in communication with the detector).

The number of electron pulses reaching the detector may be controlled by intermittent gating in dependence of the count value.

The emission of multiplied electrons may be controlled by an intermittent gating, based on the determined count value.

The number of received ions may be controlled by an intermittent gating, based on the determined count value.

Intermittent gating may take place after emitting the electrons. In one example, gating may be performed after the conversion element but before the multiplication unit. In another example, gating may take place after the first few dynodes (e.g. after the first, second, third, fourth or fifth dynode).

The emitted electrons may be attenuated by the gating.

The gate may control the propagation of the secondary electrons within the multiplying section of the detection device by attenuating the secondary electrons.

Controlling the number of multiplied electrons reaching the detector by intermittent gating may comprise intermittently switching an electrically charged grid to attenuate the emitted electrons or divert the ions from the conversion element.

Controlling the number of multiplied electrons reaching the detector by intermittent gating may comprise intermittently switching an ion optic arranged upstream of the conversion element to divert the ions from the conversion element.

Controlling the number of multiplied electrons reaching the detector by intermittent gating may comprise intermittently switching one of a plurality of dynodes within the multiplication unit, so as to attenuate all multiplied electrons within the multiplication unit.

An electrical potential may be applied to one of the dynodes (preferably one of the first few dynodes downstream within the multiplying section) so that all electrons are attenuated by this dynode, wherein this dynode serves as the gate.

Intermittent gating may take place before multiplying the emitted electrons.

Intermittent gating may take place before emitting the electrons.

The gate may be a grid in front of the detection device or within the detection device. For example, the grid may be in front of the conversion element, in front of the multiplying section (immediately downstream of the conversion element), or in between dynodes of the multiplying section.

The ions may be deflected by the gating.

The gate may control the impact of the ions to the conversion dynode by attenuating the ion stream guided to the conversion dynode. Alternatively, the gate may control the impact of the electrons to the next dynode after the conversion dynode by attenuating the electron stream between the conversion dynode and the next dynode.

Intermittent gating may be effected by a gate, which provides an “energy barrier” to block, attenuate, or divert the electrons or ions.

Intermittent gating may be performed in repeating gating cycles comprising an “off” time, wherein the number of multiplied electrons reaching the detector is attenuated (or during which the emission of multiplied electrons is stopped), and an “on” time, wherein the number of multiplied electrons reaching the detector is not attenuated (or during which the emission of multiplied electrons takes place).

The duration of the “on” time may be controlled during the intermittent gating, in dependence of the count value. The duration of the “off” time may be controlled during the intermittent gating in dependence of the count value and/or may be based on a required dead time of the detector.

The gate may operate in cycles, wherein the gate is switched between the “on” time during which the gate allows the passage of the ions or the secondary electrons and the “off” time, during which the gate attenuates the ions or the secondary electrons.

The multiplied electrons may be detected as a pulse of multiplied electrons. The pulse of the multiplied electrons may be detected by means of a detector (also called a “counting detector”) of the ion detection device.

The “off” time of each gating cycle may be greater or equal to a dead time of the detector.

The “on” time of a gating cycle may be increased if the count value of the previous gating cycle was zero.

The “on” time may be set to a duration so that the probability of the count value being greater than zero during the “on” time of at least one gating cycle is between 0.2 and 0.8, preferably between 0.4 and 0.6.

The “on” time may be increased from a pre-set duration if the count value of one or more of the previous gating cycles was zero.

The “on” time may be held constant for at least one gating cycle, if the count value of one or more of the previous gating cycles was greater than zero.

The “on” time may be decreased after a predetermined number of gating cycles if the probability of the count value being greater than zero is above 0.5 (alternatively, above 0.6, 0.7, 0.8 or 0.9).

The “on” time may be decreased after a predetermined number of gating cycles if the probability of the count value being zero is below 0.5 (alternatively, below 0.4, 0.3, 0.2 or 0.1).

The “on” time may be increased after a predetermined number of gating cycles if the probability of the count value being greater than zero is below 0.5 (alternatively, below 0.4, 0.3, 0.2 or 0.1).

The “on” time may be increased after a predetermined number of gating cycles if the probability of the count value being zero is above 0.5 (alternatively, above 0.6, 0.7, 0.8 or 0.9).

The “on” time of an initial gating cycle may be prolonged until a count value is determined from the detection signal (also called a “counting signal” or “voltage signal”).

The detection device may be maintained in an “on” mode (in which the gate allows the passage of the ions or the secondary electrons) until one count is detected and then turned to an “off” mode (in which the gate attenuates the ions or the secondary electrons). The duration of the “on” mode until the count is detected may be taken as the initial value of the “on” time for an initial gating cycle.

The “on” time may be varied between an upper and a lower threshold for a number of gating cycles, wherein the probability of the count value being greater than zero is determined from the determined count values determined during the number of cycles.

The present invention also provides an ion detection device comprising:
a conversion element for converting received ions into emitted electrons,
a multiplication unit for multiplying the emitted electrons,
a detector for detecting the multiplied electrons, producing a detection signal in response to detecting the multiplied electrons, and determining a count value from the detection signal.

The ion detection device further comprises a controller configured to control the number of multiplied electrons reaching the detector by intermittent switching of a gate in dependence of the count value determined by the detector.

The multiplication unit may be downstream of the conversion element.

The detector may be downstream of the multiplication unit.

Intermittent switching of the gate may be used to control the number of multiplied electrons reaching the detector from the multiplication unit.

The gate may be located upstream of the conversion element.

The gate may be located downstream of the conversion element.

The gate may be an electrically chargeable grid. The grid may be configured to be intermittently switched so as to attenuate and/or divert charged particles. In particular, the grid may be configured to be intermittently switched so as to attenuate the emitted electrons. Alternatively, the grid may be configured to be intermittently switched so as to divert the ions from the conversion element (and/or attenuate the ions arriving at the conversion element).

The gate may be an ion optical element arranged upstream of the conversion element. The ion optical element may be arranged to be intermittently switched so as to divert the ions from the conversion element.

The multiplication unit may be a secondary electron multiplier. One of a plurality of dynodes within the multiplication unit may be arranged to be intermittently switched so as to attenuate all multiplied electrons within the multiplication unit.

The controller may be configured to execute a method of controlling an ion detection device as described above.

The present invention also provides a mass spectrometer comprising an ion detection device as described above.

A detection device may comprise a multiplying section with a plurality of dynodes and a detection section with an electron detector. Each dynode of the plurality of dynodes may be configured to emit electrons if an ion and/or electron hits the dynode. Each dynode may have a less negative potential than the foregoing dynode. The detector may comprise a gate arranged upstream or inside the multiplying section, wherein the gate is configured to intermittently attenuate the ions of the ion stream or the secondary electrons.

The detection may be a SEM detection device. The gate may be upstream of a conversion dynode of the detection (upstream of the first dynode of the detection). One of the dynodes (preferably one of the first few dynodes downstream in the multiplying section) may act as a gate. A grid in front of the detection device or between dynodes may act as the gate. The grid may comprise a 2-dimensional grid and/or parallel wires. The gating may be provided by alternating voltage on neighboring wires.

A mass spectrometer may comprise the detection device. A mass filter (preferably quadrupole) upstream of the detection device may serve as the gate.

### BRIEF DESCRIPTION OF THE DRAWINGS

FIG. 1 illustrates an SEM detection device according to the prior art.

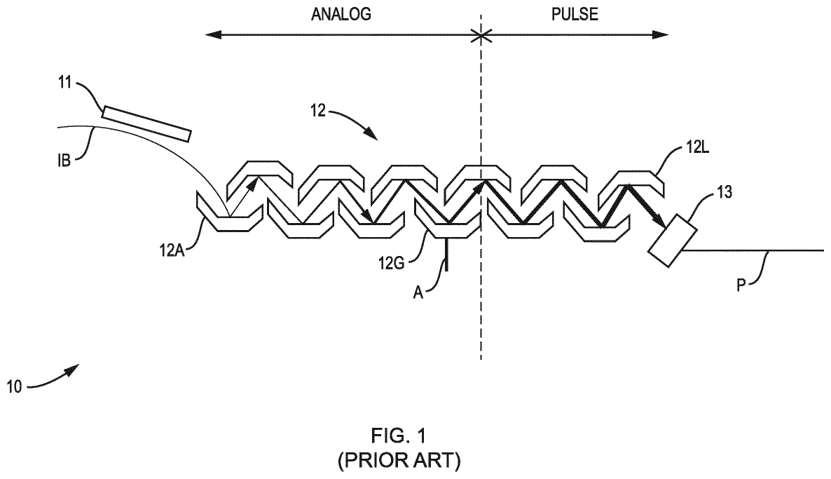

FIG. 2 illustrates an SEM detection device according to the prior art in which a gate is provided at the beginning of the counting or pulse section, after the analogue part.

FIG. 3 schematically illustrates an SEM detection arrangement according to the prior art.

FIG. 4 schematically illustrates an embodiment of an SEM detection arrangement according to the invention.

FIG. 5 schematically illustrates another embodiment of an SEM detection arrangement according to the invention.

FIG. 6 schematically illustrates a further embodiment of an SEM detection arrangement according to the invention.

FIG. 7 schematically illustrates a still further embodiment of a SEM detection arrangement according to the invention.

FIG. 8 a gating signal as may be used in the invention.

FIG. 9 schematically shows part of a gating signal as may be used in the invention.

### DETAILED DESCRIPTION OF THE INVENTION

In mass spectrometry, secondary electron multipliers may be used to aid detection of ions that have been separated by a mass analyzer. A secondary electron multiplier comprises a plurality of electrodes, called dynodes. Each dynode multiplies incident charges via a process called secondary emission, in which a single charged particle (e.g. an electron) can, when incident on a secondary-emissive material, induce emission of more electrons (e.g. between 1 and 10 electrons). An electric potential is applied between each electrode and the next electrode in the SEM. The electrons emitted by the first electrode will accelerate to the next electrode and induce secondary emission of more electrons from that electrode. This can be repeated a number of times (e.g. using 8 to 14 secondary electrodes dynodes), resulting in a large number of multiplied electrons emitted from the last electrode. The multiplied electrons may be detected either as a current, or the pulses of the multiplied electrons may be coupled either capacitively, or inductively and counted by a counting electronics circuit.

Typically, the analogue mode (in which the current is measured) is used for a low amplification mode. In contrast, a high gain is used for the counting mode. By providing dual modes, a linear dynamic range of up to nine orders of magnitude may be achieved, so that major and minor components of the sample can be measured in one run.

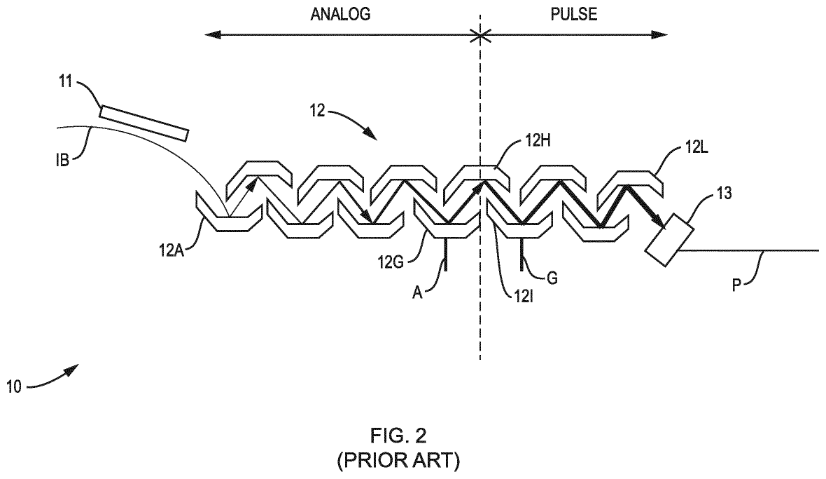

In some dual mode detectors, a gate is provided at the beginning of the counting section, after the analogue section. This is illustrated in FIG. 2. This gate is after the analogue section and is able to switch off the electron beam going into the counting section. Switching off the electron beam going into the counting section may help to increase the lifetime of the pulse detector 13.

FIG. 2 illustrates a schematic set-up of a SEM detector device 10 used in some prior art mass spectrometers. The ion detection device 10 comprises a multiplying section 12 comprising a plurality of dynodes 12A-12L and a detection section or detector 13. FIG. 2 also illustrates the schematics of the gating principle. An ion beam IB is directed towards a conversion dynode 12A of the multiplying section 12. A deflector 11 may be used to direct the ion beam (although this is optional). When the ion beam IB hits the conversion dynode 12A, the conversion dynode emits secondary electrons. The conversion dynode 12A of the detector may be set to a moderate voltage, e.g. 2 kV for typical ICP instruments or higher on other instruments. The electrons emitted from the conversion dynode are attracted by an electric field in the direction of the next dynode, where they cause multiplied emission of secondary electrons. There is a potential difference between adjacent dynodes, so that each dynode emits electrons in response to impacts of charges received from the previous dynode (or from the ion beam, in the case of the conversion dynode). In a counting mode, the electrons emitted by the last dynode 12L are directed to the detecting section or detector 13 of the detection device 10, where a detection signal output P is produced. The counting mode therefore records the electrons arriving at the last stage of the multiplying section. In an analogue mode, an analogue signal “A” is measured from a central dynode 12G within the multiplying section. Relatively high ion currents can be measured using the analogue mode, while relatively small ion currents can be measured using the counting mode. The combination of these modes is intended to provide a wider dynamic measurement range.

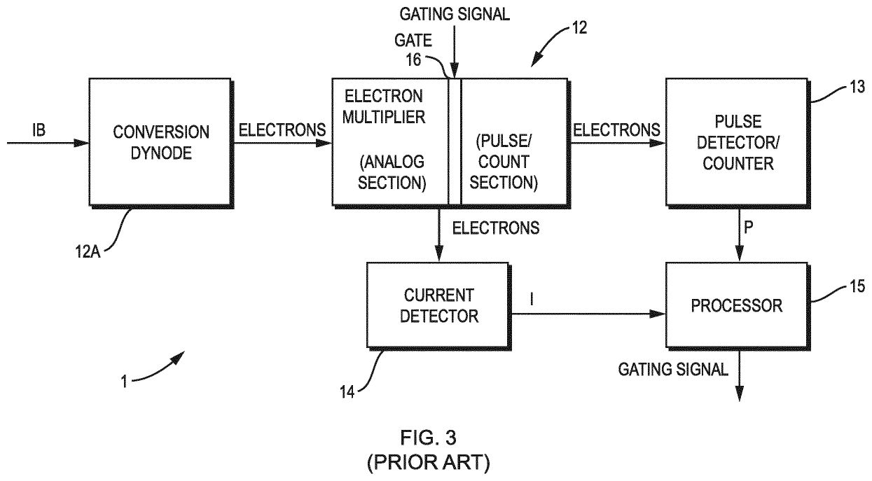

FIG. 3 schematically illustrates a SEM detector arrangement which may comprise a SEM detection device 10 as shown in FIG. 2. The SEM detector arrangement 1 of FIG. 3 comprises a conversion dynode 12A, an electron multiplier (multiplying section) 12, a pulse detector (or counter) 13, a current detector 14 and a processor 15. The multiplying section 12 comprises a gate 16 arranged between the analogue and pulse sections. The analogue section can provide electrons to the current detector 14, while the pulse section can provide pulses to the pulse detector 13. The processor 15 provides a gating signal to the gate 16, which gating signal may be based on the current I detected by the current detector or the pulses P counted by the pulse detector 13. The gating signal can switch the pulse/count section off for a period of time when pulse counting is not desired.

The need for an analogue detection mode is a source of problems in the prior art. Removing analogue detection (at least for precision measurements) would result in an improved system. However, prior art devices rely on the analogue mode, in combination with the counting mode, to increase the dynamic range of the detector to the required level. To switch between modes, a gate functionality may be provided in the dual mode detector. In the detection device of FIG. 2, a gating signal “G” is applied to a dynode 121 of the multiplying section 12 (downstream of the dynode 12G from which the analogue signal “A” is measured). In prior art devices, the gate (constituted by the dynode 121 in FIG. 2) is provided after the analogue part, and is used to switch off the electron beam going into the counting (or pulse) part. This is done by changing the voltage of at least one of the dynodes between a first voltage, where the electrons pass the dynode, and a second voltage, where they do not pass. The gating signal therefore blocks or attenuates the electrons travelling down the multiplying section, to prevent large electron pulses from reaching the detector 13.

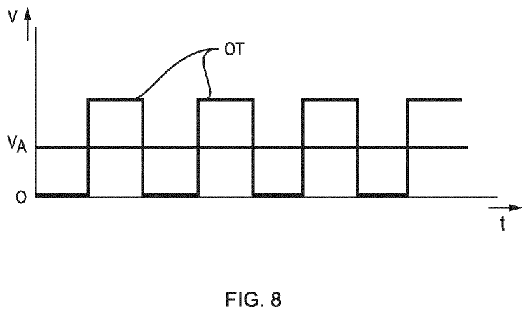

As described above, the gating function is used in prior art devices to switch between analogue and counting modes. In contrast, the present invention proposes to apply a voltage oscillation to the gate, based on the count value determined by the detector. This voltage oscillation (which may comprise a voltage switched repeatedly between two states and/or a substantially sinusoidal oscillation) will have an “on” time (during which electrons pass through the gate normally) and an “off” time (during which electrons are attenuated or blocked). Preferably, the voltage oscillation is a rectangular voltage oscillation, as illustrated in FIG. 8. However, the changes in voltage may not be instantaneous and the sides of the wave may exhibit a slight slope. In the example shown in FIG. 8, the pulses each define an “on” time (OT). In the example FIG. 8, the average voltage VA is positive.

During the “on” time, the detector may count a number of pulses (e.g. zero, one or more).

The number of pulses received at the detector is approximately Poisson distributed. The Poisson distribution expresses the probability of the number of pulses (zero, one, two etc.) occurring during the “on” time. The pulse events occur with approximately constant mean rate and also occur approximately independently of the time since the last pulse.

The detector may count pulses during the “on” time but may count no pulses during the “off” time (because the gating prevents electrons from reaching the detector or sufficiently attenuates the number).

The detector may be further configured to adapt the length of the “on” time so that pulse events occur at the detector in only part of the “on” time. These pulse events are also referred to as “counts” or simply “events”. The probability that no events occur follows the Poisson statistics:

P:=exp(−I·tₒₙ) (1)

Where I is the intensity in counts per second and where tₒₙ is the “on” time.

This can be re-written as

$$I := - \frac{ln ( P )}{{t}_{on}} \qquad ( 2 )$$

Therefore, for each “on” time (also referred to as “on” period) of a given duration tₒₙ we expect a certain probability of there being zero counts during the period and a complementary probability of there being at least one count during the period (which is one minus the probability of there being zero counts). In other words, each “on” period can be classified by one of the following complementary events:
zero pulses are detected; and
one or more pulses are detected.

The probability of there being zero pulses during the “on” time tₒₙ is estimated from the detection results and the intensity of the ion beam can be calculated using equation 2.

One way in which the probability may be estimated is by repeating an “on” time of a fixed duration over a number of cycles and counting the proportion of periods during which zero pulses are detected. The proportion is an estimate of the probability and will be more accurate with more cycles.

It is advantageous to have a probability around 0.5, therefore the “on” time tₒₙ is preferably set to a value so that approximately half the “on” periods pass without any counts being detected during the “on” period.

One reason for the probability being preferably around 0.5 is that if the probability is determined to be around 0.5, this probability is likely to be more accurate with fewer experiments (“on” times). If the probability is close to 0 then the number of periods during which we get one or more pulses will be low and therefore the estimate of the probability may be less accurate.

The present invention also provides a method to set the duration of the “on” time. As described above, the “on” time is set to tune the probability close to 0.5. Typically, it will be preferred to set the duration of the “on” time to a suitable value before intensity measurements are determined (although the “on” time may also be adjusted in a similar manner while measurements are being determined). There are a few different ways in which the duration of the “on” time may be set and these are described individually below.

In a first preferred method, the measurement from the last on-time is used and the duration of the on-time is continuously adapted.

Advantageously, the first method is possible whenever the detection signal increases (e.g. from a lower counting area region to a higher counting area region) or decreases (e.g. from a higher counting area region to a lower counting area region). This method is therefore able to react to ion beams of changing intensity and provide updated intensity readings.

In a second method, the analogue detector output is used to determine the on-time duration. This method requires a cross-calibration factor. From the mismatch between the expected probability and the observed probability, the cross-calibration factor can be updated continuously, without user interaction. The analogue output may be used for cross calibration in setting the “on” time of the counting mode but the intensity of the detection signal should preferably be measured in counting mode, rather than using the analogue mode.

A third method is to attenuate the ion beam by any lens in the mass spectrometer. For example, the quadrupole focus lens may be used to attenuate the ion beam arriving at the detection device. In this case, the following steps may be performed:

When the detection signal is higher than the normal counting range, attenuate the ion beam until the detection signal is within the counting range.

Reduce the attenuation gradually, while adjusting the on-time to the required duration, as described above. Alternatively, a stored dependency between the Q focus voltage and the attenuation may be used to provide an approximate “on” time directly.

In other words, a lens of the mass spectrometer (e.g. a quadrupole) upstream of the SEM detection device can be used to attenuate the ion beam in order to reduce the counts for the detector downstream of the multiplying section. This may be done in addition to the switching of the gate. Once the timing of the gate is established to deliver the desired detection probability within each cycle, the attenuation is reduced and the timing of the gate is re-adjusted.

A fourth method is to increase the “on” times until a suitable value is found. This method may be referred to as performing a “sweep”. The following steps may be performed:
1. Start with a short “on” time;
2. Perform a number of cycles and estimate the probability of a zero count (e.g. 100 cycles);
3. If the probability of zero counts is not at approximately 0.5, increase the “on” time;
4. Go to step 2.

The sweep can be performed by increasing the “on” time by a predetermined step size at step 3. Alternatively, the “on” time may be adjusted continuously.

Moreover, the steps of the sweep can be made with decreasing step size if the estimated probability is close to the 0.5 probability target. This can also be reversed, increasing the step size if the estimated probability is far from the 0.5 probability target.

In one example of continuous adjustment of the “on” time, there may be no need to perform a fixed number of cycles to estimate the probability. Instead, the “on” time duration may be increased for every period of zero counts and decreased for every period of one or more counts. The “on” time duration time should eventually settle around an “on” time that gives a probability of approximately 0.5.

A running average of the intensity can be taken and the probability may be estimated using the formula provided in equation (2). The sweep may be stopped when the estimate of the probability is within a predetermined threshold of the target probability (the desired accuracy is reached). This may be the case, assuming shot noise statistics, if

$$\frac{1}{\sqrt{{Counts}_{weighted}}} > {Accuracy}_{target} \qquad ( 3 )$$

$$with$$

$${Counts}_{weighted} := \sum ( P \cdot I ) \qquad ( 4 )$$

The desired accuracy may be 1% (0.01), for example.

In another example, the size of the step may be based on the estimated probability for the previous “on” time. So if the estimated probability p(zero)=0.9 then a large step size can be applied (e.g. increase “on” time by a factor of ln(0.5)/ln(0.9)=6.56) and if the estimated probability p(zero)=0.6 then a small step size can be applied (e.g. increase “on” time by a factor of ln(0.5)/ln(0.6)=1.36). In general,

$${t}_{new} := {t}_{old} \cdot \frac{ln ( 0.5 )}{ln ( {P}_{0} ( {t}_{old} ) )} \qquad ( 5 )$$

Since the number of cycles to determine the probability is small, the estimate may not be accurate. The new “on” time could then be used for an increased number of cycles to provide an updated probability and an updated tₒₙ, and so on.

A sweep could also be performed in reverse (starting with a long “on” time and decreasing). However, starting with a shorter “on” time and increasing will likely result in reaching the desired “on” time faster than starting with a longer “on” time and decreasing.

The number of “on” time events can also be varied with time. In other words, the number of cycles may be fairly low to start with, when the “on” time is likely to require significant adjustment, and increased to obtain a more accurate estimate of the probability when the “on” time is approaching the desired value (when the probability is close to 0.5).

Once the “on” time has been selected, measurements may be taken by counting the number of cycles during which zero or one or more counts are detected. The results of the counting can be used to adjust the “on” time setting for the next series of cycles.

In the fourth method, a sweep is performed over a range of “on” times. The “on” time is varied (arbitrarily, sweep) between an upper and a lower threshold for a number of cycles and the detection probability of an electron is determined from the detection results of the number of cycles.

In a fifth method, the on time is increased from a pre-set duration if no electrons were counted by the counting detector during at least one switching cycle of the gate. The “on” time is held constant for at least one cycle, if an electron has been counted by the counting detector during the previous switching cycle of the gate. The “on” time is increased after a predetermined number of switching cycles of the gate, if the probability of the detection of an electron is below 0.5.

In a sixth method, the probability for a fixed number of cycles (e.g. 100) is determined and the “on” time is increased if the probability is below 0.5. The detection probability is calculated for a number of cycles with a constant “on” time, wherein the “on” time is increased if the detection probability is below 0.5.

A seventh method is to mix pulses of different length and evaluate the result.

For example, the “on” period may be varied in steps from an upper limit to a lower limit (with one cycle for each step size). The preferred duration may be estimated from the results. This may be performed as a sweep through possible “on” times. Alternatively, a statistical mix of “on” times may be used (in other words, larger steps between less likely values and smaller steps between more likely values).

Between each repetition, a sufficient “off” time is required. The “off” time is preferably as short as possible so that the time taken is reduced. In one example, the “off” time can be set to the dead time. Alternatively, the “off” time may be shorter than the dead time (and as short as possible) unless at least one count is seen (in which case the “off” time should be the dead time). This approach may reduce the overall time taken. This applies to any of methods 1-7 mentioned above and may also apply when taking measurements.

In an eighth method, the gate is opened and the time until the first pulse arrives is measured. This is repeated a number of times (e.g. 10 times). In this case, there is a risk that several pulses may pass through the detector before the gate is closed. This is because run-time effects in the detection device may cause a delay between the electrons passing the gate and a detection signal being detected. Moreover, it may take some time after the detection signal is detected to close the gate. A second pulse may therefore pass the gate before the gate is closed.

In the eighth method, the gate is kept open until an electron is detected. The “on” time is determined by measuring the time until a first secondary electron is detected by the detector, while maintaining the gate in a state allowing the passage of the ions or the secondary electrons.

Another option is to end the “on” time immediately after a count has been registered. In this case, the run time of the pulses through the detector should also be considered.

A worked example for setting the “on” time (in accordance with the fourth, fifth and sixth methods) is provided below.

First, assume an intensity of 2 million counts per second (cps). Start with an “on” time of 1 nanosecond (ns) and an “off” time of 1 ns. The probability of 0 counts during an “on” period is 1.00 (or more precisely 0.998), from equation 1. After 10 “on” periods without event (20 ns in total) a determination is made that the “on” time should be increased.

The “on” time is then increased to 10 ns. The “off” time is set to 1 ns if there is no event and the “off” time is set to 20 ns if there are one or more events. The probability of zero events occurring during the “on” time is 0.98. After 10 “on” periods, we therefore expect to have registered 10 “on” periods during which there were no counts. This takes 110 ns.

The “on” time is then increased to 100 ns. The probability of zero events occurring during an “on” period is then 0.82. The expected number of periods during which an event occurs is 1.8. For this example, assume that there were two “on” periods during which at least one event occurred. The total duration of the “on” and “off” times is 100 ns×10 (“on” times)+20 ns×2 (“off” times following events)+1 ns×8 (“off” times following no event)=1.048 microseconds (μs). Based on the detection result the probability is estimated to be 0.8. The intensity determined from the estimated probability is therefore 2.23 million cps (from equation 2). The calculated “on” time needed to make the probability 0.5 (based on the detection result) is provided by the following equation:

$$t := - \frac{ln ( 0.5 )}{I} = 311 ns \qquad ( 6 )$$

This would give a true probability of 0.537 for zero events in this example (from equation 1). This may be accurate enough, depending on the requirements set in the method. In the preferred example, probabilities between 0.4 and 0.6 are acceptable. Therefore, this value of tₒₙ provides a probability with the acceptable range.

Overall, the determination of the correct “on” time took 1.168 μs in this example.

In another method, measurements may be taken until the shot noise limit is at a predefined value, rather than measuring for a fixed time. If an accuracy of 1% is desired, this would mean 10 thousand counts. This is because, if the noise is shot noise limited, the noise is proportional to the square root of ions. Therefore, in order to get a RMS of 1%, it needs 1/Square (0.01)=10,000 ions. In the case of 2 million cps this would need less than 0.03 sec. During this measurement, the “on” time could be fine adjusted.

In theory, the proposed methods could provide a detector with an infinite dynamic range. As long as the ions reach the second dynode as separate events, the dynamic range is only limited by the electronics, and its ability to set very short and precise “on” and “off” times. When the electronics is at its limit, e.g. the pulse shape deviates from the rectangular one, this can be calibrated.

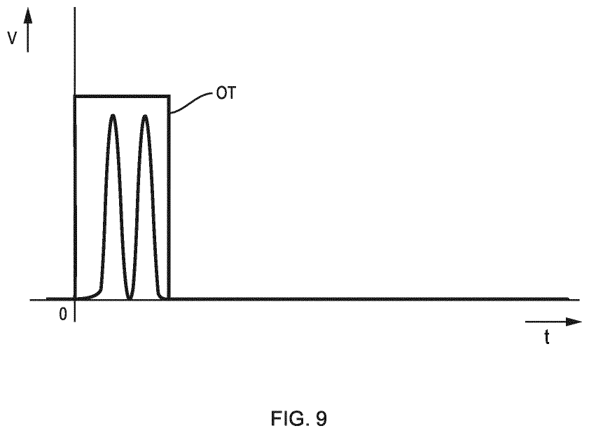

An illustrative example is provided in FIG. 9, which illustrates a graph of (part of) a gating voltage over time. Pulses received at the detector are illustrated on the same axis. During the “on” time OT, two events, that is, detector pulses occurred.

Where the beginning/initiation of an electron pulse occurs during the “on” time, the pulse will continue to be detected after the gate is closed again. Closing the gate may prevent further pulses from reaching the detector but pulses that started during the “on” time may not be blocked.

For at least this reason, it is preferable to set the “off” time at least as long as the detector dead time. In cases where a pulse beginning coincides with the end of the “on” period, the event may be detected during the “off” period (when the discriminator level is crossed). In this case, the duration of the “off” period may need to be slightly longer than the detector dead time, by at least the duration of the pulse.

There may also be a delay that is needed for the pulse to propagate through the detector. This delay is not illustrated in FIG. 9. The skilled person will understand the modifications required to account for this delay.

The ion intensity may also be calculated using the following alternative method:
1. Set the gate in the “on” position;
2. Measure the time until the first ion event is registered;
3. Set the gate in the “off” position for the dead time;
4. Repeat the above steps, and calculate the average time between the ion events.

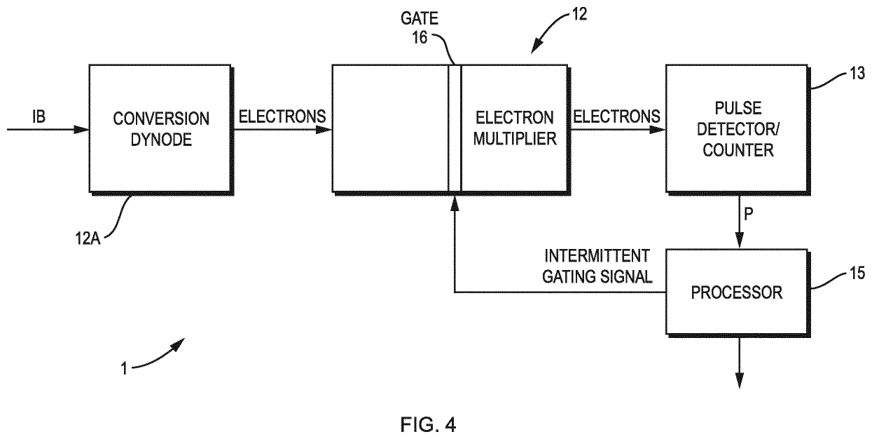

Intermittent gating may be performed at a number of different locations within the SEM detection arrangement. In a first embodiment, gating may be performed using the existing gate, that is at the existing location in the multiplying section. However, in contrast to prior art devices (which use the gate to switch between analogue and counting modes), the proposed methods apply an intermittent gating signal to the gate that is based on the determined count value. The first embodiment is illustrated in FIG. 4.

The SEM detection arrangement 1 of FIG. 4 also comprises a conversion dynode 12A, a multiplying section 12, a pulse detector or counter 13, and a processor 15, as the prior art arrangement of FIG. 3. The multiplying section 12 also comprises a gate 16 arranged between the parts or multiplying sections referred to as the analogue and pulse sections in prior art devices (in detector arrangements according to the invention, only pulses and no current may be detected, and as a result a current detector may be omitted). In accordance with the invention, the processor 15 provides an intermittent gating signal to the gate 16, which gating signal is based on the pulses P counted by the pulse detector 13. The intermittent gating signal periodically switches the downstream part of the multiplying section off.

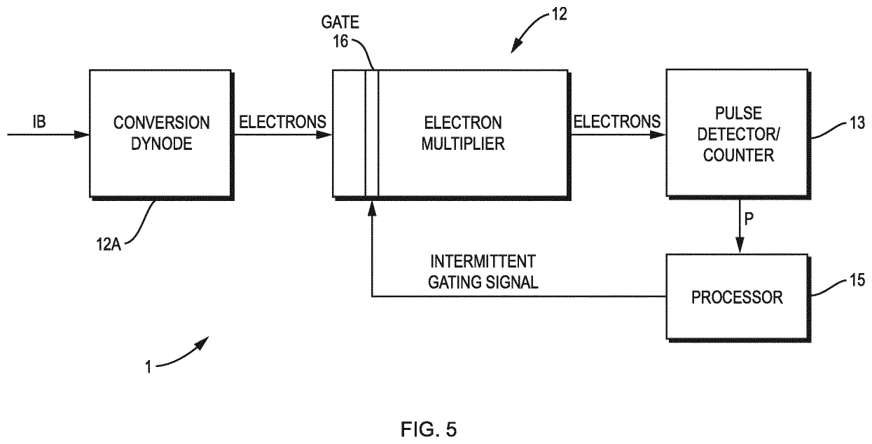

Rather than using the gate in the position that exists in dual-mode detectors (at a dynode after the analogue section AS), as schematically illustrated in FIG. 4, gating may be performed at a different dynode of the detection device (such as the conversion dynode or one of the first few dynodes). FIG. 5 illustrates the second embodiment of the invention. As can be seen in FIG. 5, the gate is moved from a location after the conventional analogue section, as in the prior art (FIG. 3), to a location towards the start of the electron multiplier 12. This location may correspond with, for example, the second, third, or fourth dynode. The current detector (14 in FIG. 3) is no longer required and is removed. The gating signal, which previously switched between analogue and counting modes, is replaced by an intermittent gating signal that is based on the determined count value. By using intermittent gating as described in this document, the dynamic range of the counting mode can be increased so that the analogue mode is not needed (at least for measuring ion intensities, although the analogue mode may be used to set tₒₙ in some methods described above).

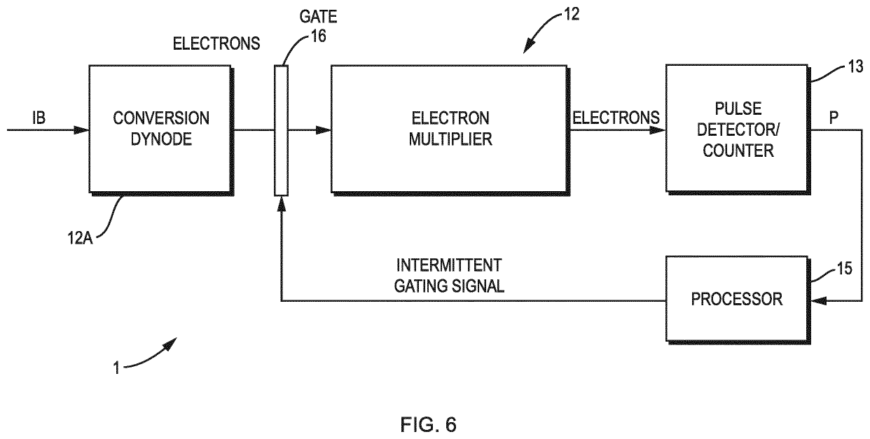

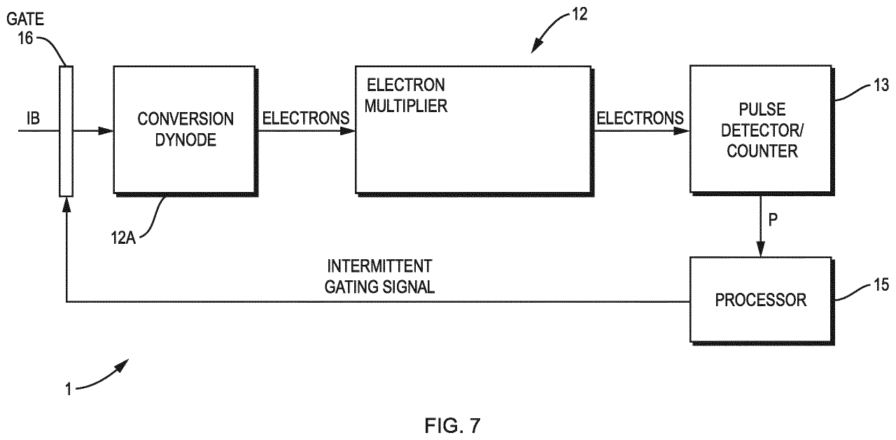

Alternatively or additionally, a grid may be provided to switch on/off the electron beam or the ion beam. Thus, the functionality of the gate may be provided by a separate grid, instead of by a dynode. The grid may be provided before the electron multiplier (as shown in the third embodiment illustrated in FIG. 6) or before the ion converter (as shown in the fourth embodiment illustrated in FIG. 7).

In the embodiment of FIG. 6, the multiplying section 12 has no gate. Instead, the gate 16 (constituted by a grid) is here arranged in front of the multiplying section 12, immediately downstream of the conversion dynode 12A. In this embodiment, the intermittent gating signal produced by the processor 15 is used to intermittently prevent electrons produced by the conversion dynode 12A from reaching the multiplying section 12. As a result, the multiplier section 12 intermittently produces electrons and the detector 13 intermittently detects electrons.

In the embodiment of FIG. 7, the multiplying section 12 has no gate either. Instead, the gate 16 (constituted by a grid) is here arranged in front of the conversion dynode 12A. In this embodiment, the intermittent gating signal produced by the processor 15 is used to intermittently prevent ions from reaching the conversion dynode. As a result, the multiplier section 12 intermittently produces electrons.

The principles described above in relation to the method may be applied wherever the gating is performed.

It is preferred to perform gating earlier in the electron multiplier than where the gate exists in prior art devices. This is because earlier gating may reduce power consumption of the device as electron multiplication is not performed when the gate is off. Moreover, the gating should preferably be performed when the pulse is as short as possible. If the gating occurs at the ions, before the SEM, the pulse would be a delta function with a pulse width of zero.

In some cases, it may be advantageous to retain the position of the gate after the analogue section, rather than to move the gate upstream. In this way, existing devises may be modified to perform the present invention with fewer changes then if the position of the gate were moved.

It may be advantageous to provide multiple gates at different stages of the device and drive all the gates with the same gating signal. In cases where the gates are only able to attenuate the charged particles, rather than completely block them, this may further reduce the total number of multiplied electrons arriving at the detector in the off mode.

As described above, there are alternative implementations in which:
a dynode after the analogue output provides the gating function (first embodiment);
one of the first dynodes is used to provide a gating function (preferably, one of the first five dynodes; second embodiment);
a grid is provided inside the SEM (third embodiment); and
another type of energy filter is provided (this may be provided by a combination of grid, deflection plates, ion choppers, special grids, and the like).

In the second embodiment, one of the dynodes before the analogue output (where the analogue output is retained) may be used to provide the gating function. In another example, the gating function may be provided by the conversion dynode, the second dynode, the third dynode, the fourth dynode or the fifth dynode.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an analogue to digital convertor) means “one or more” (for instance, one or more analogue to digital convertor). Throughout the description and claims of this disclosure, the words “comprise”, “including”, “having” and “contain” and variations of the words, for example “comprising” and “comprises” or similar, mean “including but not limited to”, and are not intended to (and do not) exclude other components.

Although embodiments according to the disclosure have been described with reference to particular types of devices and applications (particularly SEM detectors deployed in ICP-MS or iCAP™ devices) and the embodiments have particular advantages in such case, as discussed herein, approaches according to the disclosure may be applied to other types of device and/or application. The specific structural details of the instrument, whilst potentially advantageous (especially in view of known system constraints and capabilities), may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise.

All of the aspects and/or features disclosed in this specification may be combined in any combination, except combinations where at least some of such features and/or steps are mutually exclusive. As described herein, there may be particular combinations of aspects that are of further benefit, such the aspects of determining a set of compensation parameters and applying a set of compensation parameters to measurements. In particular, the preferred features of the invention are applicable to all aspects of the invention and may be used in any combination. Likewise, features described in non-essential combinations may be used separately (not in combination).

1-15. (canceled)

16. A method of controlling an ion detection device, comprising:
converting received ions into emitted electrons;
multiplying the emitted electrons;
detecting the multiplied electrons;
producing a detection signal in response;
determining an ion intensity from the detection signal; and
controlling a number of multiplied electrons reaching a detector by intermittent gating based on the ion intensity.

17. The method of claim 16, wherein determining the ion intensity from the detection signal comprises determining an ion count value, wherein the number of multiplied electrons reaching the detector is controlled by intermittent gating in dependence of the count value.

18. The method of claim 17, wherein the intermittent gating takes place:
before emitting the electrons;
after emitting the electrons; and/or
after emitting the electrons and before multiplying the emitted electrons.

19. The method of claim 16, wherein the intermittent gating takes place after emitting the electrons and before multiplying the emitted electrons.

20. The method of claim 16, wherein the emitted electrons are attenuated by the gating; and/or wherein the ions are deflected by the gating.

21. The method of claim 16, wherein controlling the number of multiplied electrons reaching the detector by intermittent gating comprises one or more of:
intermittently switching an electrically charged grid to attenuate the emitted electrons or divert the ions from a conversion element;
intermittently switching an ion optic arranged upstream of the conversion element to divert the ions from the conversion element; and
intermittently switching one of a plurality of dynodes within a multiplication unit, so as to attenuate all multiplied electrons within the multiplication unit.

22. The method of claim 16, wherein the intermittent gating is done in repeating gating cycles comprising:
an “off” time, wherein the number of multiplied electrons reaching the detector is attenuated by the intermittent gating; and
an “on” time, wherein the number of multiplied electrons reaching the detector is not attenuated by the intermittent gating.

23. The method of claim 22, wherein:
a duration of the “on” time and a duration of the “off” time are controlled during the intermittent gating in dependence on the ion intensity; and/or
the “off” time of each gating cycle is greater or equal to a dead time of the detector.

24. The method of claim 22, wherein the “on” time is set based on one or more of:
the “on” time of a gating cycle is increased if the ion intensity of the previous gating cycle was zero;
the “on” time is set to a duration so that a probability of the ion intensity being greater than zero during the “on” time of at least one gating cycle is between 0.2 and 0.8, preferably between 0.4 and 0.6;
the “on” time is increased from a pre-set duration if the ion intensity of one or more of the previous gating cycles was zero;
the “on” time is held constant for at least one gating cycle, if the ion intensity of one or more of the previous gating cycles was greater than zero;
the “on” time is decreased after a predetermined number of gating cycles if the probability of the ion intensity being greater than zero is above 0.5;
the “on” time of an initial gating cycle is prolonged until an ion intensity is determined from the detection signal; and
the “on” time is varied between an upper and a lower threshold for a number of gating cycles, wherein the probability of the ion intensity being greater than zero is determined from the determined ion intensities determined during the number of cycles.

25. An ion detection device comprising:
a conversion element for converting received ions into emitted electrons;
a multiplication unit for multiplying the emitted electrons;
a detector situated to:
detect the multiplied electrons,
produce a detection signal in response to the detected multiplied electrons, and
determine an ion intensity from the detection signal; and
a controller configured to control a number of multiplied electrons reaching the detector by intermittent switching of a gate in dependence of the ion intensity determined by the detector.

26. The ion detection device of claim 25, wherein:
the gate is located upstream of the conversion element; or
the gate is located downstream of the conversion element.

27. The ion detection device of claim 26, wherein the gate is an electrically charged grid, and wherein the grid is arranged to be intermittently switched so as to attenuate the emitted electrons, or to divert the ions from the conversion element.

28. The ion detection device of claim 25, wherein the gate is an electrically charged grid, and wherein the grid is arranged to be intermittently switched so as to attenuate the emitted electrons, or to divert the ions from a conversion element.

29. The ion detection device of claim 25, wherein the gate is an ion optic arranged upstream of the conversion element, wherein the ion optic is arranged to be intermittently switched so as to divert the ions from the conversion element.

30. The ion detection device of claim 25, wherein the multiplication unit is a secondary electron multiplier and wherein one of a plurality of dynodes within the multiplication unit is arranged to be intermittently switched so as to attenuate all multiplied electrons within the multiplication unit.

31. The ion detection device of claim 25, wherein the controller is configured to intermittently the gating in repeating gating cycles comprising:
an “off” time, wherein the number of multiplied electrons reaching the detector is attenuated by the intermittent gating; and
an “on” time, wherein the number of multiplied electrons reaching the detector is not attenuated by the intermittent gating.

32. The ion detection device of claim 31, wherein the controller is operable to set the “on” time so that:
the “on” time of a gating cycle is increased if the ion intensity of a previous gating cycle was zero;
the “on” time is set to a duration so that a probability of the ion intensity being greater than zero during the “on” time of at least one gating cycle is between 0.2 and 0.8, preferably between 0.4 and 0.6;
the “on” time is increased from a pre-set duration if the ion intensity of one or more of the previous gating cycles was zero;
the “on” time is held constant for at least one gating cycle, if the ion intensity of one or more of the previous gating cycles was greater than zero;
the “on” time is decreased after a predetermined number of gating cycles if the probability of the ion intensity being greater than zero is above 0.5;
the “on” time of an initial gating cycle is prolonged until an ion intensity is determined from the detection signal; and
the “on” time is varied between an upper and a lower threshold for a number of gating cycles, wherein the probability of the ion intensity being greater than zero is determined from the determined ion intensities determined during the number of cycles.

33. The ion detection device of claim 31, wherein the controller is operable to set a duration of the “on” time so that a probability of the ion intensity being greater than zero during the “on” time of at least one gating cycle is between 0.2 and 0.8.

34. The ion detection device of claim 31, wherein the controller is operable to set the “on” time so that the “on” time is varied between an upper and a lower threshold for a number of gating cycles, wherein a probability of the ion intensity being greater than zero is determined from the determined ion intensities determined during the number of cycles.

35. A mass spectrometer, comprising the ion detection device of claim 25.
